(19) United States
(12) Patent Application Publication
(10) Pub. No.: US 2015/0129582 A1
(43) Pub. Date: May 14, 2015

(54) SYSTEM AND METHOD FOR AUTOMATIC HEIGHT ADJUSTMENT OF A TORCH

(71) Applicant: Lincoln Global, Inc., City of Industry, CA (US)

(72) Inventor: STEPHEN R. COLE, CHULA VISTA, CA (US)

(73) Assignee: LINCOLN GLOBAL, INC., CITY OF INDUSTRY, CA (US)

(21) Appl. No.: 14/168,134

(22) Filed: Jan. 30, 2014

Related U.S. Application Data
(60) Provisional application No. 61/902,886, filed on Nov. 12, 2013.

(51) Int. Cl. B23K 9/095; B23K 9/12; B23K 9/18; B23K 9/028; B23K 9/16; B23K 9/167

(52) U.S. Cl. CPC B23K 9/0953; B23K 9/16; B23K 9/167; B23K 9/18; B23K 9/0286; B23K 9/122
USPC 219/60 R; 219/74; 219/75; 219/73; 219/73.1

(57) ABSTRACT

The invention described herein generally pertains to a system and method related to adjusting at least one of an arc current for a welding operation, an arc voltage for a welding operation, a wire feed speed for a welding operation, or a height of a torch that performs the welding operation. In particular, a parameter can be updated based upon, for instance, a user input, and the arc current, arc voltage, wire feed speed, or the height of the torch can be calibrated to perform the welding operation. Specifically, while a parameter is being adjusted or transitioned to the setting received via user input, the height of the torch and/or at least one of the arc current level, the arc voltage, the wire feed speed is maintained until the setting is achieved for the parameter. Once the parameter is at the setting, a second arc current level, a second arc voltage, a second wire feed speed, or second height for the torch is implemented to perform the welding operation.

### PRIORITY

This application claims the benefit of priority to U.S. Provisional Application Ser. No. 61/902,886, filed Nov. 12, 2013, and entitled “SYSTEM AND METHOD FOR AUTOMATIC HEIGHT ADJUSTMENT OF A TORCH.” The entirety of the aforementioned application is incorporated herein by reference.

### TECHNICAL FIELD

In general, the present invention relates to an orbital welding system or a non-orbital welding system. More particularly, the present invention relates to controlling at least one of an arc current level, a voltage, a wire feed speed, or a torch height based on an adjustment to a parameter for a welding operation.

### BACKGROUND OF THE INVENTION

Welding systems reside at the core of the modern industrial age. From massive automobile assembly operations to automated manufacturing environments, these systems facilitate joining in ever more complicated manufacturing operations. Hot wire welding processes a wire or electrode being heated (e.g., via current) and received by a puddle created by a main heat source (e.g., plasma arc, tungsten inert gas (TIG) welding, metal inert gas (MIG) welding, flux core, among others). The hot wire welding process includes the resistance heating of the up to or near a melting point of such wire. In hot wire welding processes, the formation of an arc is avoided since an arc condition disrupts or overheats the puddle. A wire heated near or close to the melting point of the wire without arcing events is received by the puddle with little or no disruption. In order to prevent a formation of an arc, a welding parameter related to the workpiece can be detected. The welding parameter can indicate an arc condition in which the hot wire welding process can be adjusted.

Additionally, welding may involve, raising, cladding, building up, filling, hard facing, overlaying, joining, and other welding applications. When confronted with a workpiece having a curved surface, an orbital welding process may be used to rotate the welding head to apply a weld to the curved surface. The most common examples, where orbital welding is used, is the welding of pipe. Pipe welding may include thin wall application where the welding head is rotated about the other surface two piece ends being joined together, alternatively, pipe welding may include deep groove geometries where the welding electrode extends into a grove formed between the two pipes being joined to lay down successive beads of weld material to fill the groove and join the thick walled pipes. Orbital welding systems may include a welding head that is mounted on a guide track or a fixture that clamps or is otherwise supported on the workpiece and rotated to supply a weld. Orbital welding often involves limited visibility of a welding zone with lead cameras and/or trailing cameras.

Welding systems can include numerous controls that can be adjusted by a user during a welding operation. For instance, conventional welding systems can include up to sixteen (16) buttons, inputs, and switches that require years of experience to comprehend and use efficiently. Often, a change in one adjustment can lead to a change in another adjustment in order to maintain consistency.

Orbital welding systems and non-orbital welding systems can be compromised by the number of adjustments a user can implement and what is needed is an improved technique to relate to preventing adjustment that is detrimental to a welding operation.

### SUMMARY OF THE INVENTION

In accordance with an embodiment of the present invention, a system that controls at least one of an arc current or a height of a torch is provided. The system includes a welding torch that includes an electrode used with a welding operation. The system further includes a power source that creates an arc between the electrode and the workpiece and a controller that adjusts height of the welding torch based upon an arc current used for the welding operation. The system includes a detect component that receives a value for a parameter that impacts the arc current for the welding operation upon change of the value for the parameter. The system includes a calibration component that calculates at least one of a second arc current level for the welding operation or a second height for the welding torch based on the value for the parameter. The controller in the system adjusts a welding equipment to transition the parameter to the value and adjusts the welding torch to the second height or the arc current to the second arc current when the parameter is transitioned to the value.

In accordance with an embodiment of the present invention, a method is provided that includes at least the steps of the following: creating an arc between an electrode and a workpiece; delivering a welding wire to a puddle formed by the electrode; receiving a user input for a setting of a parameter, wherein the setting changes an arc current of the arc; maintaining an arc current level of the arc and a contact tip to work distance for the electrode and the workpiece while simultaneously transitioning the parameter to the setting; calibrating the arc current level to a second arc current level based on the setting; calibrating the contact tip to work distance to a second contact tip to work distance based on the setting; and depositing the welding wire onto the workpiece with the setting for the parameter, the second arc current level, and the second contact tip to work distance.

In accordance with an embodiment of the present invention, a welder system is provided that includes at least the following: an orbital welder having a chassis supported adjacent to a workpiece; a welding torch coupled to the chassis that includes an electrode; a power source that creates an arc between the electrode and the workpiece; a wire feeder that is connected to a supply of welding wire to provide a welding wire to a puddle formed by the electrode; means for receiving a user input for a setting of a parameter, wherein the setting changes an arc current of the arc; means for maintaining an arc current level of the arc and a contact tip to work distance for the electrode and the workpiece while simultaneously transitioning the parameter to the setting; means for calibrating the arc current level to a second arc current level based on the setting; means for calibrating the contact tip to work distance to a second contact tip to work distance based on the setting; means for depositing the welding wire onto the workpiece with the setting for the parameter, the second arc current level, and the second contact tip to work distance; and means for utilizing at least one transition phase to change at least one of the arc current level to the second arc current level or the contact tip to work distance to the second contact tip to work distance.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates a front view of an orbital welding system;

FIG. 2A illustrates a side view of an orbital welding system;

FIG. 2B illustrates a perspective view of an orbital welding system;

FIG. 3A is a diagram illustrating portion of a hot wire welding system;

FIG. 3B is a diagram illustrating portion of a hot wire welding system;

FIG. 4 is a diagram illustrating a welder system that automatically adjusts an arc current for a welding operation;

FIG. 5 is a flow diagram of managing a height of a welding torch based on a change in a value of a parameter for a welding operation;

FIG. 6 is a flow diagram of controlling an arc current of an arc in a welding operation based on a received user input; and

FIG. 7 is a flow diagram of performing a welding operation with an automatic adjusting arc current and contact tip to work distance based on a change to at least one of an arc voltage, a wire feed speed, or a travel speed of a tractor welder.

### DETAILED DESCRIPTION OF THE INVENTION

Embodiments of the invention relate to methods and systems that relate to adjusting an arc current for a welding operation, a voltage for the welding operation, a wire feed speed for the welding operation, or a height of a torch that performs the welding operation. In particular, a parameter can be updated based upon, for instance, a user input, and the arc current or the height of the torch can be calibrated to perform the welding operation. Specifically, while a parameter is being adjusted or transitioned to the setting received via user input, the height of the torch and/or the arc current level is maintained until the setting is achieved for the parameter. Once the parameter is at the setting, a second arc current level or second height for the torch is implemented to perform the welding operation. By maintaining the current level and height until the transition is completed, a recalibration allows the welding operation to be within desired tolerances without manual adjustment of multiple parameters. Further, the recalibration can utilize a transition phase that gradually changes the arc current to the second arc current and/or the height to the second height. In the example of adjusting the arc current and/or the height, the welding operation can be a MIG welding operation.

In another embodiment, a parameter can be updated based upon, for instance, a user input, and the voltage level or the height of the torch can be calibrated to perform the welding operation. Specifically, while a parameter is being adjusted or transitioned to the setting received via user input, the height of the torch and/or the voltage is maintained until the setting is achieved for the parameter. Once the parameter is at the setting, a second voltage level or second height for the torch is implemented to perform the welding operation. By maintaining the voltage level and height until the transition is completed, a recalibration allows the welding operation to be within desired tolerances without manual adjustment of multiple parameters. Further, the recalibration can utilize a transition phase that gradually changes the voltage level to the second voltage level and/or the height to the second height. In the example of adjusting the voltage level and/or the height, the welding operation can be a TIG welding operation.

In another embodiment, a parameter can be updated based upon, for instance, a user input, and the wire feed speed or the height of the torch can be calibrated to perform the welding operation. Specifically, while a parameter is being adjusted or transitioned to the setting received via user input, the height of the torch and/or the wire feed speed is maintained until the setting is achieved for the parameter. Once the parameter is at the setting, a second wire feed speed or second height for the torch is implemented to perform the welding operation. By maintaining the wire feed speed and height until the transition is completed, a recalibration allows the welding operation to be within desired tolerances without manual adjustment of multiple parameters. Further, the recalibration can utilize a transition phase that gradually changes the wire feed speed to the second wire feed speed and/or the height to the second height. In the example of adjusting the wire feed speed and/or the height, the welding operation can be a sub-arc welding operation.

“Welding” or “weld” as used herein including any other formatives of these words will refer to depositing of molten material through the operation of an electric arc including but not limited to submerged arc, GTAW, GMAW, MAG, MIG, TIG welding, or any electric arc used with a welding system.

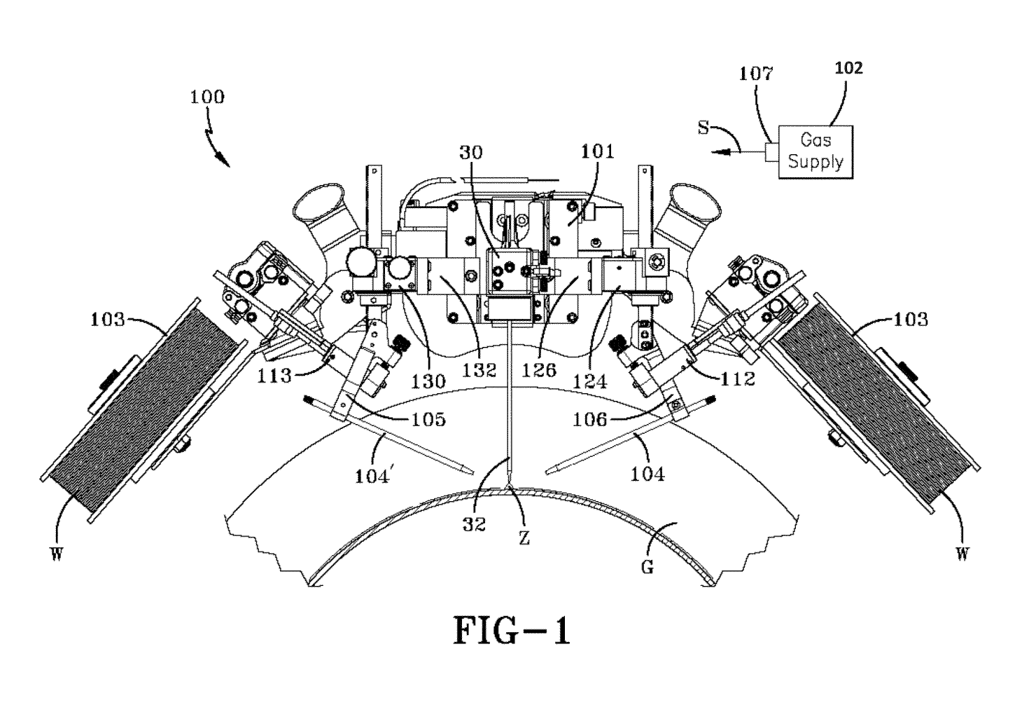

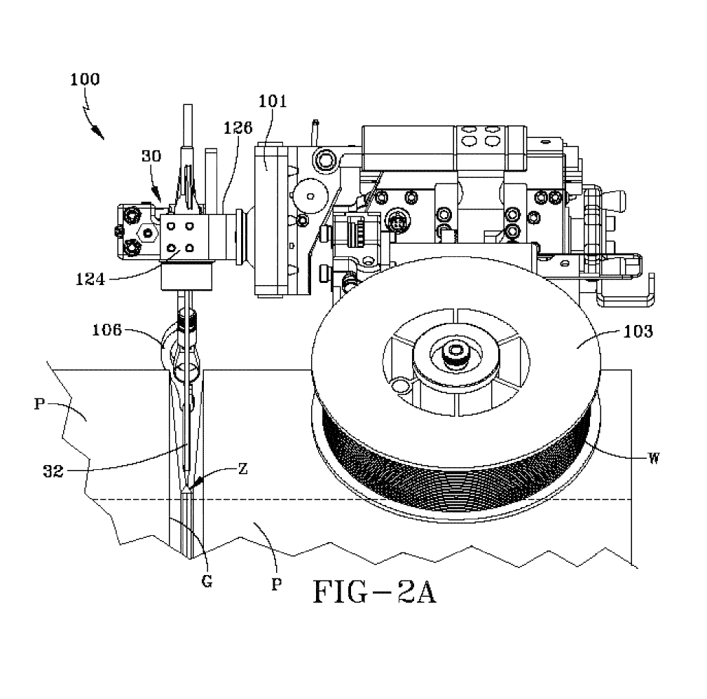

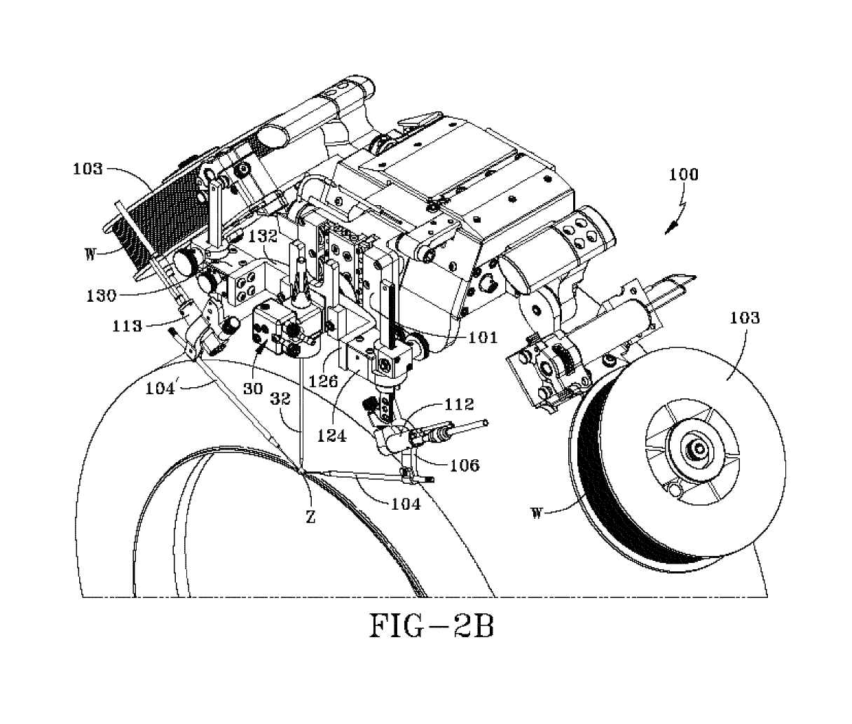

The best mode for carrying out the invention will now be described for the purposes of illustrating the best mode known to the applicant at the time of the filing of this patent application. The examples and figures are illustrative only and not meant to limit the invention, which is measured by the scope and spirit of the claims. Referring now to the drawings, wherein the showings are for the purpose of illustrating an exemplary embodiment of the invention only and not for the purpose of limiting same, FIGS. 1-4 illustrate a welding system that is used with an automated or semi-automated welding system. One illustrative example of a welding system is orbital welding, which is often used for the joining of tubes or pipes of various types of materials. For example, a Tungsten Inert Gas (TIG) or Gas Tungsten Arc Welding (GTAW) welding torch may be used to orbit around the pipes to be welded together by an automated mechanical system. FIGS. 1-2B illustrate an example embodiment of orbital welding system 100 (also referred to as welder, system, welding system, and/or welder system) as used in an orbital welding environment. Orbital welding system 100 includes a welding tractor (not shown) that travels around the pipes or tubes, a welding power source (not shown) and controller (not shown), and a pendant (not shown) providing operator control. It is to be appreciated that the subject innovation can be used with any orbital or non-orbital welding system. Moreover, the subject innovation can be used with any welding operation that includes an arc and a hot wire that is liquefied to deposit welding material onto a workpiece.

System 100 (as seen in FIGS. 1-2B) is generally used in deep groove welding. In the example shown, welding system 100 includes an orbital TIG welder having a welder body or chassis 101, which may be attached to the work piece or supported on a track. Welder 100 includes a welding torch, generally indicated at 30, having a welding electrode 32 for depositing weld material to form a weld joint at welding zone Z. Electrode 32 is an extended electrode having an electrode length suitable for the groove G being welded. Extended electrode 32 may have any length suitable for a given deep groove weld, including lengths greater than 10 millimeters. As depicted in the example shown, electrode length may be greater than 100 millimeters. The particular example shown has a length of about 120 millimeters. This example is not limiting as electrodes having greater or lesser lengths may be used depending on the depth of the groove G.

Welding torch 30 is connected to a shield gas supply 102, that provides an inert gas, such as Argon gas, to welding torch 30. Welding gas supply 102 may include a container, such as a cylinder, that stores shield gas S under pressure, and delivery of shield gas S, via appropriate tubing or other conduits, may be controlled by a regulator or other controller 107. A non-pressurized source may be used also with gas delivery provided by a pump or the like. When welding thick plates or heavy wall pipes, the weld joint design typically provides a narrow groove to permit an elongated electrode to be placed in the joint with some adjustment of the torch angle to assure a good weld created by layering a series of weld beads upon each other until the joint is filled. This process may be referred to as narrow groove welding or deep groove welding interchangeably throughout the following description. Narrow groove welding is a process where successive single bead weld layers are applied on top of one another in a narrow groove or joint. One of the considerations in the narrow groove environment is maintaining sufficient shield gas to protect the molten weld puddle from atmospheric contamination. Typically, an inert shield gas, such as Argon, is provided from outside the weld joint with a long electrode extending into the groove below the shield gas supply.

The welder may include a wire feeder connected to a supply of welding wire, such as a spool 103 that provides tungsten wire W to one or more wire guides 104′, 104. In the example shown, a pair of extended wire guides 104′, 104 are provided and fed by independent spools 103 located on either side of chassis 101. The extended wire guides 104′, 104 are supported on first camera device and wire guide system 105 (also referred to as first mount system 105) and second camera device and wire guide system 106 (also referred to as second mount system 106) respectively that are each laterally outward of electrode 32 and above the workpiece or pipe P. It is to be appreciated that the support for the extended wire guides 104′, 104 can be chosen with sound engineering judgment without departing from the intended scope of coverage of the embodiments of the subject invention.

The orbital welding system can include wire guides 104′, 104 can include a position device that provides automated or semi-automated motion, wherein the motion can be in any direction within a 3-dimensional environment in proximity to an arc created within welding zone Z. For instance, the wire guides 104′, 104 can extend inward and downward toward electrode 32 and welding zone Z. The example welder is supported on a track and drive by a tractor drive around pipe (also referred to as workpiece W) with wire guides 104′, 104 being located in lead and lag positions relative to welding electrode 32. In an embodiment, first mount system 105 is coupled to height adjustment device 130 that allows adjustment of first mount system 105 toward welding zone Z or away welding zone Z. It is to be appreciated that the adjustment toward welding zone Z or away welding zone Z can be automated or semi-automated. Further, the adjustment can be to a side of the welding zone Z or to an opposite side of the welding zone Z (e.g., a left motion, a right motion, etc.). Height adjustment device 130 is further coupled to support member 132 that is coupled to a portion of chassis 101 of welder system 100. Similarly, second mount system 106 is coupled to height adjustment device 124 that allows adjustment of second mount system 106 toward welding zone Z or away welding zone Z. It is to be appreciated that the adjustment toward welding zone Z or away from welding zone Z can be automated or semi-automated. Further, the adjustment can be to a side of the welding zone Z or to an opposite side of the welding zone Z (e.g., a left motion, a right motion, etc.). Height adjustment device 124 is further coupled to support member 126 that is coupled to a portion of chassis 101 of welder system 100.

First mount system 105 supports camera device 113 and wire guide 104′, wherein both camera device 113 and wire guide 104′ are positioned to aim on or toward welding zone Z. Similarly, second mount system 106 supports camera device 112 and wire guide 104, wherein both camera device 112 and wire guide 104 are positioned to aim on or toward welding zone Z. It is to be appreciated that system 100 includes camera device 112 and camera device 113 but such devices are solely for illustrating various embodiments and are not to be considered limiting on the subject innovation. It is to be appreciated that camera device 113 and wire guide 104′ move together (or independently) with welder system 100 which enables supply of welding wire consistently at welding zone Z and/or where wire is fed from wire guide 104′. It is to be appreciated that camera device 112 and wire guide 104 can move together (or independently) with welder system 100, which enables supply of welding wire consistently at welding zone Z and/or where wire is fed from wire guide 104′ and ultimately from wire feeder (wire supply or spool 103).

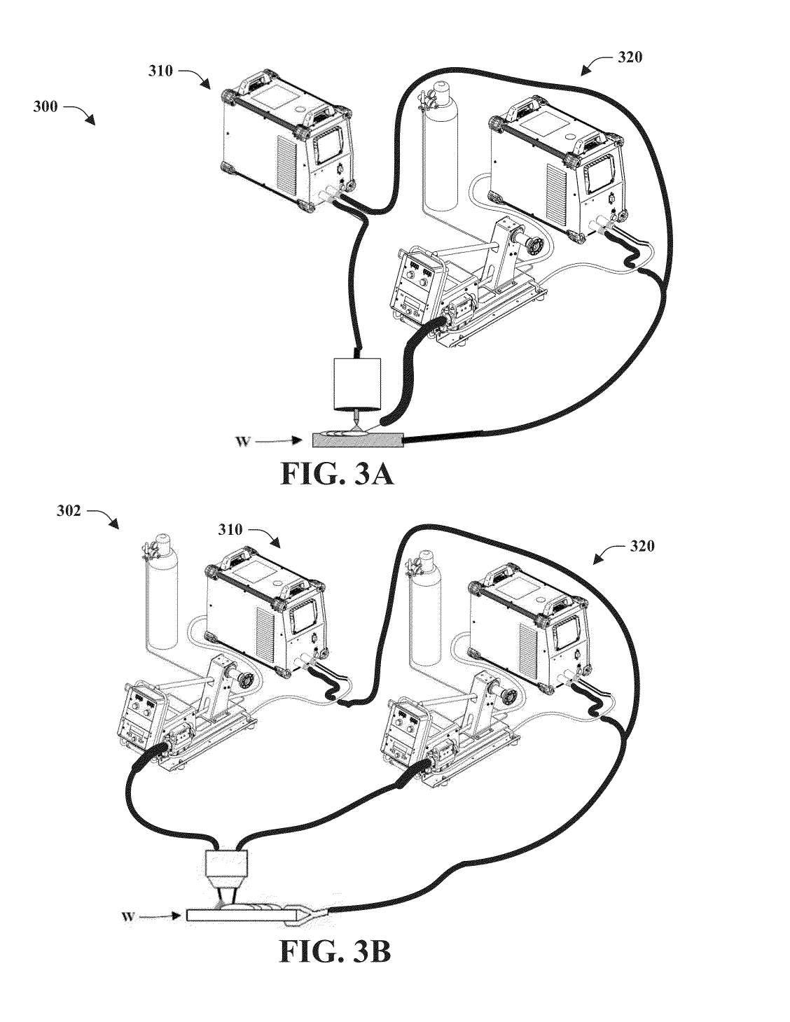

FIGS. 3A and 3B illustrate diagrams of a hot wire welding system 300 and a hot wire welding system 302 in accordance with the subject innovation. For instance, hot wire welding system 300 can be a TIG welding system and hot wire welding system 302 can be a MIG welding system. As discussed above, it is to be appreciated and understood that any suitable hot wire welder system can be implemented with the subject innovation and such systems in FIGS. 1-3B are not to be limiting on the scope of the subject claims. System 300 includes a first power supply 310 that provides a first heat source to create an arc between an electrode (e.g., a non-consumable electrode for instance) and a workpiece W, wherein a puddle is created by the electrode. System 300 further includes hot wire power supply 320 (e.g., welding wire power supply) that heats a welding wire fed into a puddle formed by the electrode. In other words, hot wire power supply 320 can energize a welding wire that is fed or delivered into the puddle to deposit welding material (e.g., liquefied welding wire) onto workpiece W.

System 302 includes a first power supply 310 that provides a first heat source to create an arc between an electrode (e.g., a non-consumable electrode for instance) and a workpiece W, wherein a puddle is created by the electrode. System 302 further includes hot wire power supply 320 (e.g., welding wire power supply) that heats a welding wire fed into a puddle formed by the electrode. In other words, hot wire power supply 320 can energize a welding wire that is fed or delivered into the puddle to deposit welding material (e.g., liquefied welding wire) onto workpiece W. It is to be appreciated that welding systems 100, 300 and 302 can be chosen and used with sound engineering judgment without departing from the intended scope of coverage of the embodiments of the subject invention.

It is to be appreciated that systems 300 and 302 can be a hot wire TIG welder system or a hot wire tandem welder system. The subject innovation can relate to an arc that is created by any suitable wire processes, wherein such wire processes can include non-consumable electrode processes.

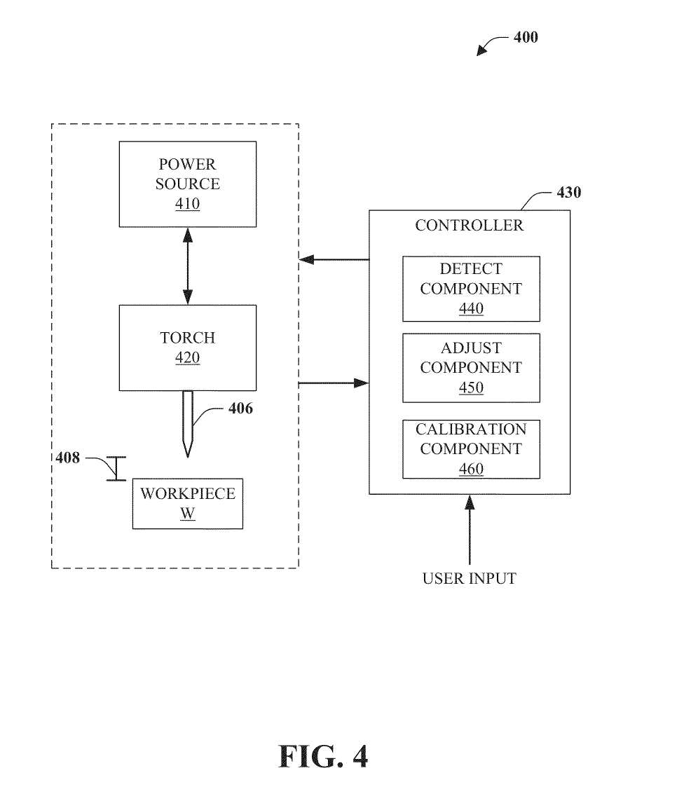

FIG. 4 illustrates welder system 400 that adjusts at least one of a height of torch 420 or an arc current level for a welding operation performed with torch 420. System 400 includes a wire guide that directs welding wire to a welding zone that includes an arc that is generated between electrode 406 and workpiece W. Torch 420 in system 400 includes electrode 406 in which power source 410 creates the arc between electrode 406 and workpiece W. Torch 420 has a height 408 that is a distance between electrode 406 and workpiece W, wherein height 408 can be referred to as contact tip to work distance, torch head space, stick out, and the like. In particular, height 408 can be adjusted by at least changing a position of torch 420 relative to workpiece W, changing a position of workpiece W relative to torch 420, or a combination thereof.

System 400 can include a controller 430 that is configured to control at least one parameter related to a welding operation performed on workpiece W. Based on a change of a welding parameter from one value to another value, controller 430 can manage at least one of height 408 of torch 420 or an arc current level for the welding operation. It is to be appreciated that the arc current level for the welding operation can be adjusted via a change of height 408 of torch 420. For instance, an increase in height 408 (e.g., movement of torch 420 away from workpiece W) can decrease the arc current level and a decrease in height 408 (e.g., movement of torch 420 toward workpiece W) can increase the arc current level. As discussed above, the movement can be provided by moving torch 420, moving workpiece W, or a combination thereof.

In another embodiment, based on a change of a welding parameter from one value to another value, controller 430 can manage at least one of height 408 of torch 420 or an voltage level for the welding operation. It is to be appreciated that the voltage level for the welding operation can be adjusted via a change of height 408 of torch 420. For instance, an increase in height 408 (e.g., movement of torch 420 away from workpiece W) can increase the voltage level and a decrease in height 408 (e.g., movement of torch 420 toward workpiece W) can decrease the voltage level. As discussed above, the movement can be provided by moving torch 420, moving workpiece W, or a combination thereof.

In another embodiment, a change of a welding parameter from one value to another value, controller 430 can manage at least one of height 408 of torch 420 or a wire feed speed for the welding operation. It is to be appreciated that the wire feed speed for the welding operation can be adjusted to compensate for a change of a welding parameter via a change of height 408 of torch 420. For instance, an increase in height 408 (e.g., movement of torch 420 away from workpiece W) can compensate for a change in a welding parameter related to a decrease in the wire feed speed and a decrease in height 408 (e.g., movement of torch 420 toward workpiece W) can compensate for a change in a welding parameter related to an increase the wire feed speed. As discussed above, the movement can be provided by moving torch 420, moving workpiece W, or a combination thereof. In general, a change in a welding parameter that affects the wire feed speed can be compensated by a change in at least one of the wire feed speed and/or a change of height 408 of torch 420.

Based on a change to a welding parameter from one value to another value during the welding operation, controller 430 manages height 408 and/or at least one of the arc current level, the voltage level, or the wire feed speed to perform the welding operation. In an example, the change to the welding parameter can be based on a user input, an electronic signal, a remote signal, and the like. For instance, a user can provide input via a device such as, but not limited to, a pendant (e.g., a device that communicates with a welding system), a remote, a keypad, a smartphone, a toggle switch, an analog switch, a digital switch, a knob, a laptop, a microphone, a camera, a video camera, a touch screen, a wired device, a wireless device, and the like. In another embodiment, the user can provide the input via a voice command, a hand gesture, a data upload, a data transfer, a data transfer via a USB port, a transfer of data from a removable hard drive, a transfer of data from a network, among others.

System 400 automatically adjusts height 408 and/or at least one of the arc current level, the voltage level, or the wire feed speed for a welding operation based on a change in a welding parameter, wherein the welding parameter impacts at least one of the arc current level, the voltage level, or the wire feed speed. In other words, when a parameter of the welding operation is changed (e.g., increased or decreased) from one value to another value and that change directly results in a change to at least one of the arc current level, the voltage, or the wire feed speed, system 400 provides adjustment to at least one of height 408, arc current level, voltage, and/or wire feed speed without user intervention or action. Generally, the welding parameter can be, but is not limited to being, a welding parameter that affects at least one of arc current level for the welding operation, voltage for the welding operation, or wire feed speed for the welding operation. Yet, it is to be appreciated that the welding parameter can be, but is not limited to being, an arc voltage, a travel speed of a tractor welder that performs the welding operation, a wire feed speed, an arc current level, a height of torch 420, a distance between workpiece W and torch 420, an oscillation width of electrode 406, a temperature of welding wire, a temperature of electrode, a type of material of workpiece W, a frequency of oscillation of electrode 406, a polarity of the arc current, a polarity of the current for welding wire, a parameter that affects an arc current of the welding operation, and the like.

Controller 430 can include detect component 440 that is configured to detect a user input that changes a parameter from an established value to another value, wherein the change to the parameter will affect an established value for at least one of arc current, arc voltage, or wire feed speed. For example, detect component 440 can receive the user input and ascertain whether the user input changes a value of a parameter that would change the value of the established arc current level for the welding operation. In another example, detect component 440 can receive the user input and ascertain whether the user input changes a value of a parameter that would change the value of the established arc voltage level for the welding operation. In another example, detect component 440 can receive the user input and ascertain whether the user input changes a value of a parameter that would change the value of the established wire feed speed for the welding operation.

Controller 430 can further include adjust component 450. Adjust component 450 provides adjustment to arc current level via change in height 408. It is to be appreciated that a change to the established value for arc current level or height 408 can be implemented directly. For instance, a user input that changes the established arc current level can result in adjust component 450 implementing the change by adjusting height 408. In another example, adjust component 450 can move torch 450 or workpiece W based on a user input that changes height 408.

Adjust component 450 is further configured to maintain the established arc current level for the welding operation while the change to the parameter is implemented. For instance, if a user input changes a parameter from one value to another and that change is identified by detect component 440 to change the established arc current, adjust component 450 maintains the established arc current prior to changing the parameter to another value. In particular, adjust component 450 transitions the parameter from the established value to another value (defined by the user input) while maintaining the established arc current.

Controller 430 can further include calibration component 460 that is configured to calibrate the arc current level for the welding operation based on the change to the parameter. The change of the parameter from the established value to the second value impacts the established arc current level. Thus, adjust component 450 maintains the established arc current level while transitioning the parameter from the established value to the second value. Moreover, calibration component 460 calculates a second arc current level, and in turn, a second height 408 for torch 420 based on the second value of the parameter. Upon completion of the transition from the established value of the parameter to the second value for the parameter, calibration component 460 implements the second arc current level and/or the second height 408 of torch 420. It is to be appreciated that system 400 can employ a transition phase with the second arc current level and/or the second height 408 of torch 420 to allow for a gradual change of from established value of the arc current or the established value of the height.

In an embodiment, adjust component 450 provides adjustment to arc voltage level via change in height 408. It is to be appreciated that a change to the established value for arc voltage level or height 408 can be implemented directly. For instance, a user input that changes the established arc voltage level can result in adjust component 450 implementing the change by adjusting height 408. In another example, adjust component 450 can move torch 450 or workpiece W based on a user input that changes height 408.

Adjust component 450 is further configured to maintain the established arc voltage level for the welding operation while the change to the parameter is implemented. For instance, if a user input changes a parameter from one value to another and that change is identified by detect component 440 to change the established arc voltage, adjust component 450 maintains the established arc voltage prior to changing the parameter to another value. In particular, adjust component 450 transitions the parameter from the established value to another value (defined by the user input) while maintaining the established arc voltage.

Calibration component 460 can be further configured to calibrate the arc voltage level for the welding operation based on the change to the parameter. The change of the parameter from the established value to the second value impacts the established arc voltage level. Thus, adjust component 450 maintains the established arc voltage level while transitioning the parameter from the established value to the second value. Moreover, calibration component 460 calculates a second arc voltage level, and in turn, a second height 408 for torch 420 based on the second value of the parameter. Upon completion of the transition from the established value of the parameter to the second value for the parameter, calibration component 460 implements the second arc voltage level and/or the second height 408 of torch 420. It is to be appreciated that system 400 can employ a transition phase with the second arc voltage level and/or the second height 408 of torch 420 to allow for a gradual change of from established value of the arc voltage or the established value of the height.

In an embodiment, adjust component 450 provides adjustment to height 408 to compensate for a change in the welding parameter that affects wire feed speed. It is to be appreciated that a change to the established value for wire feed speed or height 408 can be implemented directly. For instance, a user input that changes the established wire feed speed can result in adjust component 450 compensating for the change by adjusting height 408. In another example, adjust component 450 can move torch 450 or workpiece W based on a user input that changes height 408.

Adjust component 450 is further configured to maintain the established wire feed speed for the welding operation while the change to the parameter is implemented. For instance, if a user input changes a parameter from one value to another and that change is identified by detect component 440 to cause an affect (e.g., increase, decrease, etc.) to the wire feed speed, adjust component 450 maintains the established wire feed speed prior to changing the parameter to another value. In particular, adjust component 450 transitions the parameter from the established value to another value (defined by the user input) while maintaining the wire feed speed.

Calibration component 460 can be further configured to calibrate the wire feed speed for the welding operation based on the change to the parameter. The change of the parameter from the established value to the second value impacts the established wire feed speed. Thus, adjust component 450 maintains the established wire feed speed while transitioning the parameter from the established value to the second value. Moreover, calibration component 460 calculates a second wire feed speed, and in turn, a second height 408 for torch 420 based on the second value of the parameter, wherein the second height 408 can compensate for the impact of the established wire feed speed. Upon completion of the transition from the established value of the parameter to the second value for the parameter, calibration component 460 implements the second wire feed speed and/or the second height 408 of torch 420. It is to be appreciated that system 400 can employ a transition phase with the second wire feed speed and/or the second height 408 of torch 420 to allow for a gradual change of from established value of the wire feed speed or the established value of the height.

For example, the transition employed by adjust component 450 for changing a parameter from an established value to a second value can be a linear increase, a linear decrease, a slope, a per-parameter slope, a predefined slope, an exponential decay, an exponential growth, a stepped increased (e.g., increase by 5 units, decrease by 5 units, etc.), a time based transition (e.g., change from the established parameter to the second parameter in a period of time), a dynamically determined slope, among others. For instance, a period of time can be defined which is used to identify a slope for changing the parameter from one value to another. By way of example, a time period of 5 seconds can be defined in which a change of 1 arc voltage to 6 arc voltage would translate to a transition of 1 volt per second. It is to be appreciated that the transition can be selected with sound engineering judgment without departing from the scope of the subject innovation. Moreover, the transition can be specific to each parameter. By way of example and not limitation, a first transition can be used for arc voltage, a second transition can be used for wire feed speed, and a third transition can be used for tractor travel speed.

For example, the transition phase employed by adjust component 450 for changing 1) the established arc current to a second arc current and/or 2) the established height of torch to a second height of torch 420 can be a linear increase, a linear decrease, a slope, a per-parameter slope, a predefined slope, an exponential decay, an exponential growth, a stepped increased (e.g., increase by 5 units, decrease by 5 units, etc.), a time based transition (e.g., change from the established parameter to the second parameter in a period of time), a dynamically determined slope, among others.

For example, the transition phase employed by adjust component 450 for changing 1) the established arc voltage to a second arc voltage and/or 2) the established height of torch to a second height of torch 420 can be a linear increase, a linear decrease, a slope, a per-parameter slope, a predefined slope, an exponential decay, an exponential growth, a stepped increased (e.g., increase by 5 units, decrease by 5 units, etc.), a time based transition (e.g., change from the established parameter to the second parameter in a period of time), a dynamically determined slope, among others.

For example, the transition phase employed by adjust component 450 for changing 1) the established wire feed speed to a second wire feed speed and/or 2) the established height of torch to a second height of torch 420 can be a linear increase, a linear decrease, a slope, a per-parameter slope, a predefined slope, an exponential decay, an exponential growth, a stepped increased (e.g., increase by 5 units, decrease by 5 units, etc.), a time based transition (e.g., change from the established parameter to the second parameter in a period of time), a dynamically determined slope, among others.

In an embodiment, the parameter can be an arc voltage, a wire feed speed, or a travel speed of a tractor welder that performs the welding operation, wherein system 400 automatically adjusts at least one of height 408 of torch 420 or an arc current level of a welding operation based a user request to change the established parameter to a second parameter. It is to be appreciated the user request (also referred to as user input) can be a change to a numeric value of a parameter, wherein the change can be an increase or a decrease to the numeric value. By way of example, a user input can be received via an input device (e.g., remote, pendent, tablet, button, keypad, touch screen, etc.) that changes a value for at least one of the arc voltage, the wire feed speed, the travel speed, height 408 of torch 420, or an arc current.

For example, if the user input changes the arc current level, system 400 adjusts height 408 of torch 420. In another example, if the user input changes height 408 of torch 420, system 400 adjusts height 408 and in turn the arc current. In still another example, if the user input changes one of the arc voltage to a second arc voltage, the wire feed speed to a second wire feed speed, or the travel speed to a second travel speed, controller 430 provides a transition period for the second value (e.g., at least one of the second arc voltage, the second wire feed speed, the second travel feed speed) while maintaining the established arc current and/or established height 408. Upon completion of the transition, controller 430 calculates and employs a second arc current and/or second height 408 based upon one of the second arc voltage, the second wire feed speed, or the second travel feed speed.

For example, if the user input changes the arc voltage level, system 400 adjusts height 408 of torch 420. In another example, if the user input changes height 408 of torch 420, system 400 adjusts height 408 and in turn the arc voltage. In still another example, if the user input changes an established welding parameter from a first value to a second value, controller 430 provides a transition period to provide a change from the first value to the second value while maintaining the established arc voltage and/or established height 408. Upon completion of the transition, controller 430 calculates and employs a second arc voltage and/or second height 408 based upon the second value of the established welding parameter. In still another example, if the user input changes one of the arc current to a second arc current, the wire feed speed to a second wire feed speed, or the travel speed to a second travel speed, controller 430 provides a transition period for the second value (e.g., at least one of the second arc current, the second wire feed speed, the second travel feed speed) while maintaining the established arc voltage and/or established height 408. Upon completion of the transition, controller 430 calculates and employs a second arc voltage and/or second height 408 based upon one of the second arc current, the second wire feed speed, or the second travel feed speed

For example, if the user input changes the wire feed speed, system 400 adjusts height 408 of torch 420. In another example, if the user input changes height 408 of torch 420, system 400 adjusts height 408 and in turn affects the wire feed speed. In still another example, if the user input changes an established welding parameter from a first value to a second value, controller 430 provides a transition period to provide a change from the first value to the second value while maintaining the established wire feed speed and/or established height 408. Upon completion of the transition, controller 430 calculates and employs a second wire feed speed and/or second height 408 based upon the second value of the established welding parameter. In still another example, if the user input changes one of the arc voltage to a second arc voltage, the arc current to a second arc current, or the travel speed to a second travel speed, controller 430 provides a transition period for the second value (e.g., at least one of the second arc voltage, the second arc current, the second travel feed speed) while maintaining the established wire feed speed and/or established height 408. Upon completion of the transition, controller 430 calculates and employs a second wire feed speed and/or second height 408 based upon one of the second arc voltage, the second arc current, or the second travel feed speed.

It is to be appreciated and understood that system 400 can include various configurations and embodiments and the configuration in system 400 is not to be limiting on the subject innovation. Controller 430 can be a stand-alone component (as depicted), incorporated into power source 410, incorporated into torch 420, incorporated into detect component 440, incorporated into adjust component 450, incorporated into calibration component 460, or any suitable combination thereof. Detect component 440 can be a stand-alone component, incorporated into power source 410, incorporated into torch 420, incorporated into controller 430 (as depicted), incorporated into adjust component 450, incorporated into calibration component 460, or any suitable combination thereof. Adjust component 450 can be a stand-alone component, incorporated into power source 410, incorporated into torch 420, incorporated into controller 430 (as depicted), incorporated into detect component 440, incorporated into calibration component 460, or any suitable combination thereof. Calibration component 450 can be a stand-alone component, incorporated into power source 410, incorporated into torch 420, incorporated into controller 430 (as depicted), incorporated into adjust component 450, incorporated into detect component 440, or any suitable combination thereof.

In an embodiment, the controller transitions the welding torch to the second height or the arc current to the second arc current with a transition phase. In an embodiment, the parameter is at least one of an arc voltage, a wire feed speed, or a tractor travel speed.

In an embodiment, the welding equipment is a power source for the welding torch. In an embodiment, wherein the welding equipment is a wire feeder for the welding operation. In an embodiment, the welding equipment is a motor that controls a gear mechanism that maneuvers a tractor welder that performs the welding operation on a track relative to the workpiece.

In an embodiment, the system can further include an input device that receives the value of the parameter. In an embodiment, the input device is at least one of a keypad, a button, a toggle switch, an analog switch, a digital switch, or a knob. In an embodiment, the input device is at least one of a microphone, a touch screen, a camera, or a video camera.

In an embodiment, the controller adjusts the height of the welding torch with a movement of the welding torch in at least one of a direction toward the workpiece or a direction away from the workpiece. In an embodiment, the controller adjusts the height of the welding torch with a movement of the workpiece in at least one of a direction toward the welding torch or a direction away from the welding torch. In an embodiment, the controller further maintains the arc current or the height while the welding equipment transitions the parameter to the value.

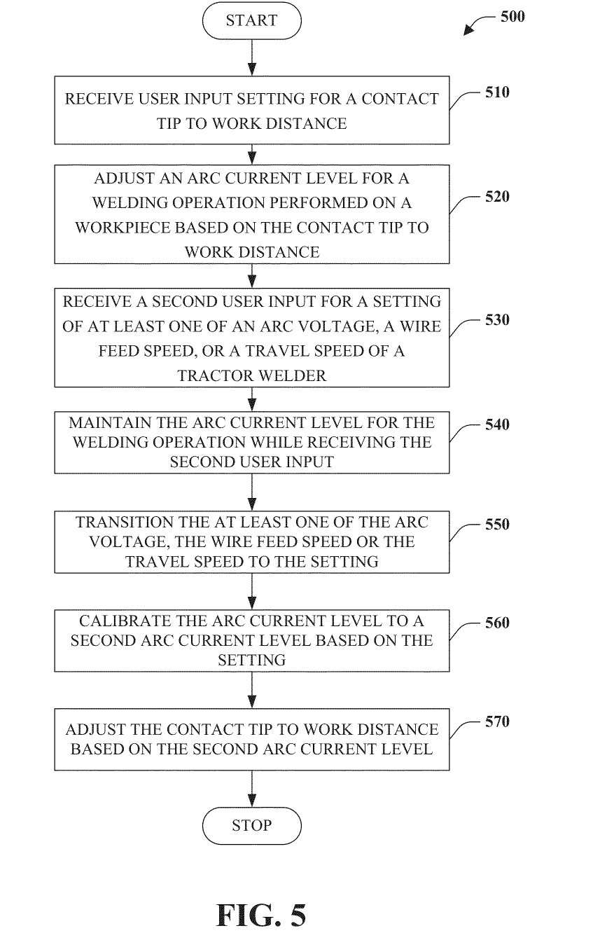

In view of the exemplary devices and elements described supra, methodologies that may be implemented in accordance with the disclosed subject matter will be better appreciated with reference to the flow charts and/or methodologies of FIG. 5-7 The methodologies and/or flow diagrams are shown and described as a series of blocks, the claimed subject matter is not limited by the order of the blocks, as some blocks may occur in different orders and/or concurrently with other blocks from what is depicted and described herein. Moreover, not all illustrated blocks may be required to implement the methods and/or flow diagrams described hereinafter.

FIG. 5 illustrates method 500 that automatically adjusts an arc current for a welding operation based on a change of a parameter from a user input. Sequentially, the following occurs as illustrated in the decision tree flow diagram 500 of FIG. 5 which is a flow diagram 500 that provides performing a welding operation. For example, a welding operation can include at least the following: creating an arc between an electrode and a workpiece; delivering a welding wire to a puddle formed by the electrode; and depositing the welding wire onto the workpiece.

A user input for a contact tip to work distance can be received (reference block 510). An arc current level for a welding operation on a workpiece can be adjusted based on the contact tip to work distance (reference block 520). A second user input for a setting of at least one of an arc voltage, a wire feed speed, or a travel speed of a tractor welder can be received (reference block 530). The arc current level for the welding operation can be maintained while receiving the second user input (reference block 540). The at least one of the arc voltage, the wire feed speed, or the travel speed can be transitioned to the setting (reference block 550). The arc current level can be calibrated to a second arc current level based on the setting (reference number 560). The contact tip to work distance can be adjusted based on the second arc current level (reference number 570). In an embodiment, the calibration of the arc current level to the second arc current level can be employed with a transition phase (discussed above). For instance, the welding operation can be a MIG welding operation.

In another embodiment, a method can be related to adjusting an arc voltage. A user input for a contact tip to work distance can be received. An arc voltage level for a welding operation on a workpiece can be adjusted based on the contact tip to work distance. A second user input for a setting of at least one of an arc current, a wire feed speed, or a travel speed of a tractor welder can be received. The arc voltage level for the welding operation can be maintained while receiving the second user input. The at least one of the arc current, the wire feed speed, or the travel speed can be transitioned to the setting. The arc voltage level can be calibrated to a second arc voltage level based on the setting. The contact tip to work distance can be adjusted based on the second arc voltage level. In an embodiment, the calibration of the arc voltage level to the second arc voltage level can be employed with a transition phase (discussed above). For instance, the welding operation can be a TIG welding operation.

In another embodiment, a method can be related to adjusting wire feed speed. A user input for a contact tip to work distance can be received. A wire feed speed for a welding operation on a workpiece can be adjusted based on the contact tip to work distance. A second user input for a setting of at least one of an arc current, an arc voltage, or a travel speed of a tractor welder can be received. The wire feed speed for the welding operation can be maintained while receiving the second user input. The at least one of the arc current, the arc voltage, or the travel speed can be transitioned to the setting. The wire feed speed can be calibrated to a second wire feed speed based on the setting. The contact tip to work distance can be adjusted based on the second wire feed speed. In an embodiment, the calibration of the wire feed speed to the second wire feed speed can be employed with a transition phase (discussed above). For instance, the welding operation can be a sub-arc welding operation.

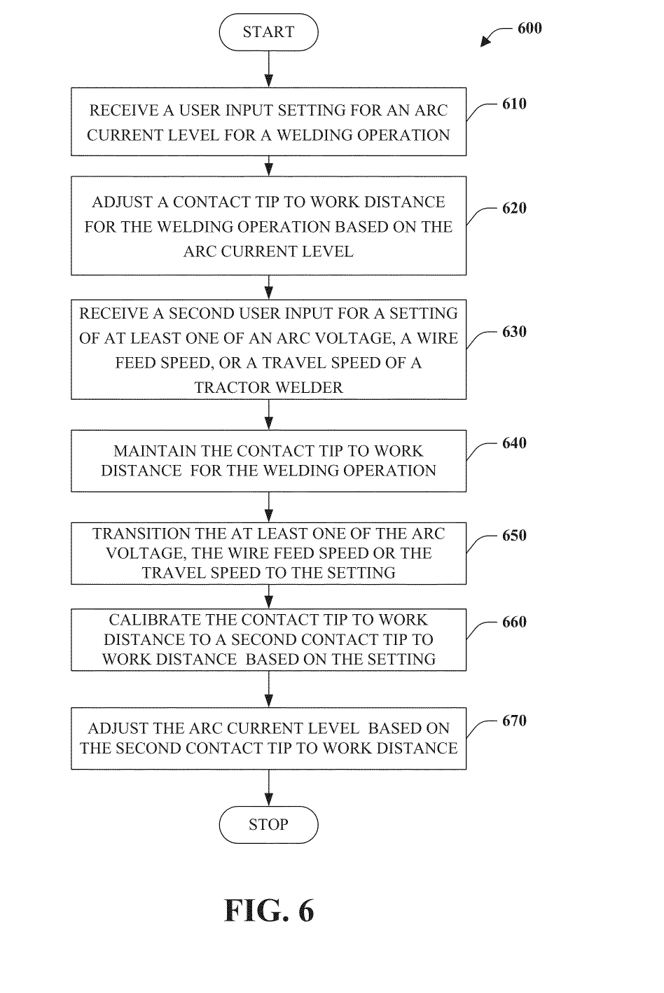

FIG. 6 illustrates method 600 that automatically adjusts height for a welding torch used in a welding operation based on a change of a parameter from a user input. For example, method 600 can relate to a welding operation that can include the following: creating an arc between an electrode and a workpiece; delivering a welding wire to a puddle formed by the electrode; and depositing the welding wire onto the workpiece. A user input setting for an arc current level for a welding operation can be received (reference block 610). A contact tip to work distance for the welding operation can be adjusted based on the arc current level (reference block 620). A second user input for a setting of at least one of an arc voltage, a wire feed speed, or a travel speed of a tractor welder can be received (reference block 630). The contact tip to work distance for the welding operation can be maintained (reference block 640). The at least one of the arc voltage, the wire feed speed, or the travel speed can be transition to the setting (reference block 650). The contact tip to work distance can be calibrated to a second contact tip to work distance based on the setting (reference block 660). The arc current level can be adjusted based on the second contact tip to work distance (reference block 670). In an embodiment, a transition phase can be utilized when changing the contact tip to work distance to the second contact tip to work distance (discussed above). For instance, the welding operation can be a MIG welding operation.

In another embodiment, a method can be related to adjusting an arc voltage. A user input setting for an arc voltage level for a welding operation can be received. A contact tip to work distance for the welding operation can be adjusted based on the arc voltage level. A second user input for a setting of at least one of an arc current, a wire feed speed, or a travel speed of a tractor welder can be received. The contact tip to work distance for the welding operation can be maintained. The at least one of the arc current, the wire feed speed, or the travel speed can be transition to the setting. The contact tip to work distance can be calibrated to a second contact tip to work distance based on the setting. The arc voltage level can be adjusted based on the second contact tip to work distance. In an embodiment, a transition phase can be utilized when changing the contact tip to work distance to the second contact tip to work distance. For instance, the welding operation can be a TIG welding operation.

In another embodiment, a method can be related to adjusting wire feed speed. A user input setting for an wire feed speed for a welding operation can be received. A contact tip to work distance for the welding operation can be adjusted based on the wire feed speed. A second user input for a setting of at least one of an arc current, an arc voltage, or a travel speed of a tractor welder can be received. The contact tip to work distance for the welding operation can be maintained. The at least one of the arc current, the arc voltage, or the travel speed can be transition to the setting. The contact tip to work distance can be calibrated to a second contact tip to work distance based on the setting. The wire feed speed can be adjusted based on the second contact tip to work distance. In an embodiment, a transition phase can be utilized when changing the contact tip to work distance to the second contact tip to work distance. For instance, the welding operation can be a sub-arc welding operation.

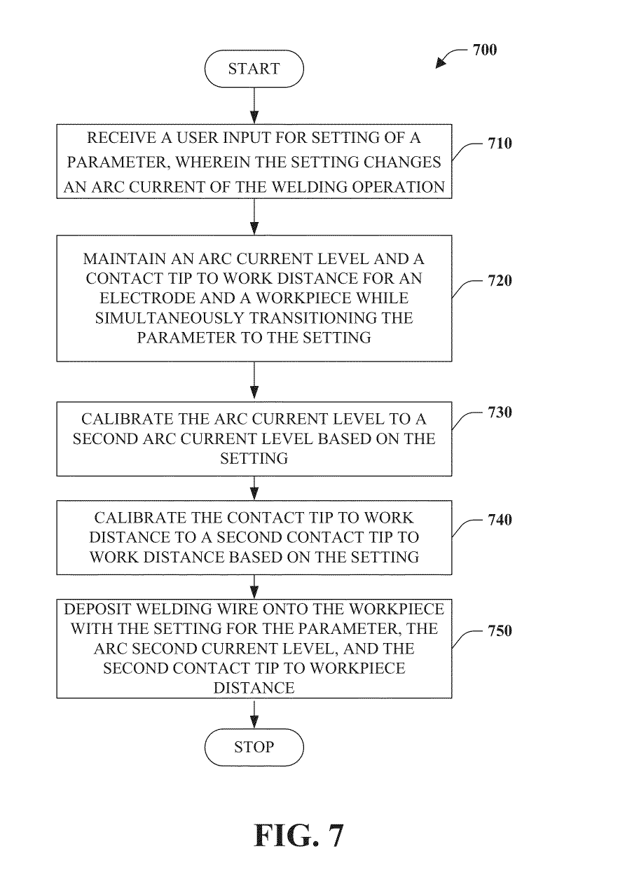

FIG. 7 is method 700 for performing a welding operation with an automatic adjusting arc current and contact tip to work distance based on a change to at least one of an arc voltage, a wire feed speed, or a travel speed of a tractor welder. Method 700 relates to a welding operation that can include various steps. An arc can be created between an electrode and a workpiece. A welding wire can be delivered to a puddle formed by the electrode. A user input for a setting of a parameter can be received, wherein the setting changes an arc current of the arc (reference block 710). An arc current level of the arc can be maintained and a contact tip to work distance for the electrode and the workpiece can be maintained while simultaneously transitioning the parameter to the setting (reference block 720). The arc current level can be calibrated to a second arc current level based on the setting (reference block 730). The contact tip to work distance can be calibrated to a second contact tip to work distance based on the setting (reference block 740). The welding wire can be deposited onto the workpiece with the setting for the parameter, the second arc current level, and the second contact tip to work distance (reference block 750). For instance, the welding operation can be a MIG welding operation.

In another embodiment, a method can be related to adjusting an arc voltage. A user input for a setting of a parameter can be received, wherein the setting changes an arc voltage of the arc. An arc voltage level of the arc can be maintained and a contact tip to work distance for the electrode and the workpiece can be maintained while simultaneously transitioning the parameter to the setting. The arc voltage level can be calibrated to a second arc voltage level based on the setting. The contact tip to work distance can be calibrated to a second contact tip to work distance based on the setting. The welding wire can be deposited onto the workpiece with the setting for the parameter, the second arc voltage level, and the second contact tip to work distance. For instance, the welding operation can be a TIG welding operation.

In another embodiment, a method can be related to adjusting a wire feed speed. A user input for a setting of a parameter can be received, wherein the setting changes a wire feed speed of the welding operation. A wire feed speed of the arc can be maintained and a contact tip to work distance for the electrode and the workpiece can be maintained while simultaneously transitioning the parameter to the setting. The wire feed speed can be calibrated to a second wire feed speed based on the setting. The contact tip to work distance can be calibrated to a second contact tip to work distance based on the setting. The welding wire can be deposited onto the workpiece with the setting for the parameter, the second wire feed speed, and the second contact tip to work distance. For instance, the welding operation can be a sub-arc welding operation.

In an embodiment, the method can further include controlling the arc current of the arc with the contact tip to work distance. In an embodiment, the parameter is at least one of an arc voltage, a wire feed speed, or a tractor travel speed. In an embodiment, transitioning the parameter to the setting includes changing a setting related to at least one of a power source for a welding torch, a wire feeder, or a welding tractor power source. In an embodiment, the transitioning of the parameter to the setting is at least one of a linear increase, a linear decrease, or a predefined slope that ramps the parameter to the setting over a period of time. In an embodiment, the transitioning of the parameter to the setting is a time based transition. In an embodiment, the method can further include utilizing at least one transition phase to change at least one of the arc current level to the second arc current level or the contact tip to work distance to the second contact tip to work distance.

While the embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit of scope of the above discussed inventions. The embodiments and discussions herein can be readily incorporated into any of these systems and methodologies by those skilled in the art.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A welder system, comprising:
a welding torch that includes an electrode used with a welding operation, wherein the welding operation is a MIG welding operation;
a power source that creates an arc between the electrode and the workpiece;
a controller that adjusts height of the welding torch based upon an arc current used for the welding operation;
a detect component that receives a value for a parameter that impacts the arc current for the welding operation upon change of the value for the parameter;
a calibration component that calculates at least one of a second arc current level for the welding operation or a second height for the welding torch based on the value for the parameter;
the controller adjusts a welding equipment to transition the parameter to the value; and
the controller adjusts the welding torch to the second height or the arc current to the second arc current when the parameter is transitioned to the value.

2. The welder system of claim 1, the controller transitions the welding torch to the second height or the arc current to the second arc current with a transition phase.

3. The welder system of claim 1, the parameter is at least one of an arc voltage, a wire feed speed, or a tractor travel speed.

4. The welder system of claim 1, wherein the welding equipment is a power source for the welding torch.

5. The welder system of claim 1, wherein the welding equipment is a wire feeder for the welding operation.

6. The welder system of claim 1, wherein the welding equipment is a motor that controls a gear mechanism that maneuvers a tractor welder that performs the welding operation on a track relative to the workpiece.

7. The welder system of claim 1, further comprising an input device that receives the value of the parameter.

8. The welder system of claim 7, wherein the input device is at least one of a keypad, a button, a toggle switch, an analog switch, a digital switch, or a knob.

9. The welder system of claim 7, wherein the input device is at least one of a microphone, a touch screen, a camera, or a video camera.

10. The welder system of claim 1, wherein the controller adjusts the height of the welding torch with a movement of the welding torch in at least one of a direction toward the workpiece or a direction away from the workpiece.

11. The welder system of claim 1, wherein the controller adjusts the height of the welding torch with a movement of the workpiece in at least one of a direction toward the welding torch or a direction away from the welding torch.

12. The welder system of claim 1, wherein the controller further maintains the arc current or the height while the welding equipment transitions the parameter to the value.

13. A method of a MIG welding operation, comprising:
creating an arc between an electrode and a workpiece;
delivering a welding wire to a puddle formed by the electrode;
receiving a user input for a setting of a parameter, wherein the setting changes an arc current of the arc;
maintaining an arc current level of the arc and a contact tip to work distance for the electrode and the workpiece while simultaneously transitioning the parameter to the setting;
calibrating the arc current level to a second arc current level based on the setting;
calibrating the contact tip to work distance to a second contact tip to work distance based on the setting; and
depositing the welding wire onto the workpiece with the setting for the parameter, the second arc current level, and the second contact tip to work distance.

14. The method of claim 13, further comprising controlling the arc current of the arc with the contact tip to work distance.

15. The method of claim 13, wherein the parameter is at least one of an arc voltage, a wire feed speed, or a tractor travel speed.

16. The method of claim 13, wherein transitioning the parameter to the setting includes changing a setting related to at least one of a power source for a welding torch, a wire feeder, or a welding tractor power source.

17. The method of claim 13, wherein the transitioning of the parameter to the setting is at least one of a linear increase, a linear decrease, or a predefined slope that ramps the parameter to the setting over a period of time.

18. The method of claim 13, wherein the transitioning of the parameter to the setting is a time based transition.

19. The method of claim 18, further comprising utilizing at least one transition phase to change at least one of the arc current level to the second arc current level or the contact tip to work distance to the second contact tip to work distance.

20. A welder system that performs a MIG welding operation, comprising:
an orbital welder having a chassis supported adjacent to a workpiece;
a welding torch coupled to the chassis that includes an electrode;
a power source that creates an arc between the electrode and the workpiece;
a wire feeder that is connected to a supply of welding wire to provide a welding wire to a puddle formed by the electrode;
means for receiving a user input for a setting of a parameter, wherein the setting changes an arc current of the arc;
means for maintaining an arc current level of the arc and a contact tip to work distance for the electrode and the workpiece while simultaneously transitioning the parameter to the setting;
means for calibrating the arc current level to a second arc current level based on the setting;
means for calibrating the contact tip to work distance to a second contact tip to work distance based on the setting;
means for depositing the welding wire onto the workpiece with the setting for the parameter, the second arc current level, and the second contact tip to work distance; and
means for utilizing at least one transition phase to change at least one of the arc current level to the second arc current level or the contact tip to work distance to the second contact tip to work distance.

21. A welder system, comprising:
a welding torch that includes an electrode used with a welding operation, wherein the welding operation is a TIG welding operation;
a power source that creates an arc between the electrode and the workpiece;
a controller that adjusts height of the welding torch based upon an arc voltage used for the welding operation;
a detect component that receives a value for a parameter that impacts the arc voltage for the welding operation upon change of the value for the parameter;
a calibration component that calculates at least one of a second arc voltage level for the welding operation or a second height for the welding torch based on the value for the parameter;
the controller adjusts a welding equipment to transition the parameter to the value; and
the controller adjusts the welding torch to the second height or the arc voltage to the second arc voltage when the parameter is transitioned to the value.

22. The welder system of claim 21, the controller transitions the welding torch to the second height or the arc voltage to the second arc voltage with a transition phase.

23. The welder system of claim 21, the parameter is at least one of an arc current, a wire feed speed, or a tractor travel speed.

24. The welder system of claim 21, wherein the welding equipment is at least one of a power source for the welding torch, a wire feeder for the welding operation, or a motor that controls a gear mechanism that maneuvers a tractor welder that performs the welding operation on a track relative to the workpiece.

25. The welder system of claim 21, further comprising an input device that receives the value of the parameter.

26. The welder system of claim 21, wherein the controller adjusts the height of the welding torch with a movement of the welding torch in at least one of a direction toward the workpiece or a direction away from the workpiece.

27. The welder system of claim 21, wherein the controller adjusts the height of the welding torch with a movement of the workpiece in at least one of a direction toward the welding torch or a direction away from the welding torch.

28. The welder system of claim 21, wherein the controller further maintains the arc voltage or the height while the welding equipment transitions the parameter to the value.

29. A method of a TIG welding operation, comprising:
creating an arc between an electrode and a workpiece;
delivering a welding wire to a puddle formed by the electrode;
receiving a user input for a setting of a parameter, wherein the setting changes an arc voltage of the arc;
maintaining an arc voltage level of the arc and a contact tip to work distance for the electrode and the workpiece while simultaneously transitioning the parameter to the setting;
calibrating the arc voltage level to a second arc voltage level based on the setting;
calibrating the contact tip to work distance to a second contact tip to work distance based on the setting; and
depositing the welding wire onto the workpiece with the setting for the parameter, the second arc voltage level, and the second contact tip to work distance.

30. The method of claim 29, further comprising controlling the arc voltage of the arc with the contact tip to work distance.

31. The method of claim 29, wherein the parameter is at least one of an arc current, a wire feed speed, or a tractor travel speed.

32. The method of claim 31, further comprising utilizing at least one transition phase to change at least one of the arc voltage level to the second arc voltage level or the contact tip to work distance to the second contact tip to work distance.

33. A welder system, comprising:
a welding torch that includes an electrode used with a welding operation, wherein the welding operation is a sub-arc welding operation;
a power source that creates an arc between the electrode and the workpiece;
a controller that adjusts height of the welding torch based upon a wire feed speed used for the welding operation;
a detect component that receives a value for a parameter that impacts the wire feed speed for the welding operation upon change of the value for the parameter;
a calibration component that calculates at least one of a second wire feed speed for the welding operation or a second height for the welding torch based on the value for the parameter;
the controller adjusts a welding equipment to transition the parameter to the value; and
the controller adjusts the welding torch to the second height or the wire feed speed to the second wire feed speed when the parameter is transitioned to the value.

34. The welder system of claim 33, the controller transitions the welding torch to the second height or the wire feed speed to the second wire feed speed with a transition phase.

35. The welder system of claim 33, the parameter is at least one of an arc current, an arc voltage, or a tractor travel speed.

36. The welder system of claim 33, wherein the welding equipment is at least one of a power source for the welding torch, a wire feeder for the welding operation, or a motor that controls a gear mechanism that maneuvers a tractor welder that performs the welding operation on a track relative to the workpiece.

39. The welder system of claim 33, wherein the controller adjusts the height of the welding torch with a movement of the welding torch in at least one of a direction toward the workpiece or a direction away from the workpiece.

40. The welder system of claim 33, wherein the controller adjusts the height of the welding torch with a movement of the workpiece in at least one of a direction toward the welding torch or a direction away from the welding torch.

41. The welder system of claim 33, wherein the controller further maintains the wire feed speed or the height while the welding equipment transitions the parameter to the value.

42. A method of a sub-arc welding operation, comprising:
creating an arc between an electrode and a workpiece;
delivering a welding wire to a puddle formed by the electrode;
receiving a user input for a setting of a parameter, wherein the setting affects a wire feed speed;
maintaining the wire feed speed and a contact tip to work distance for the electrode and the workpiece while simultaneously transitioning the parameter to the setting;
calibrating the wire feed speed to a second wire feed speed based on the setting;
calibrating the contact tip to work distance to a second contact tip to work distance based on the setting; and
depositing the welding wire onto the workpiece with the setting for the parameter, the second wire feed speed, and the second contact tip to work distance.

43. The method of claim 42, further comprising controlling the wire feed speed with the contact tip to work distance.

44. The method of claim 42, wherein the parameter is at least one of an arc current, an arc voltage, or a tractor travel speed.

45. The method of claim 42, further comprising utilizing at least one transition phase to change at least one of the wire feed speed to the second wire feed speed or the contact tip to work distance to the second contact tip to work distance.
